(19) United States
(12) Patent Application Publication
(10) Pub. No.: US 2011/0306505 A1
(43) Pub. Date: Dec. 15, 2011

(54) X-STR multiplex PCR amplification system

(75) Inventors: Chien-Wei CHANG, Belmont, CA (US); Lori HENNESSY, San Mateo, CA (US)

(73) Assignee: LIFE TECHNOLOGIES CORPORATION, Carlsbad, CA (US)

(21) Appl. No.: 13/092,887

(22) Filed: Apr. 22, 2011

Related U.S. Application Data
(60) Provisional application No. 61/327,073, filed on Apr. 22, 2010.

(51) Int. Cl. C40B 30/00

(52) U.S. Cl. 506/7

(57) ABSTRACT

The methods and compositions provided herein relate to the discovery of several new STR alleles and a 20-plex multiplex assay for markers found on the human X chromosome. These X-STR markers have been found when used in a multiplex reaction to provide higher discriminatory power when compared to existing X-STR assay kits available commercially. Embodiments of the present teachings include methods for allelic determination of X-STR markers, amplification primers for the analysis of X-STR markers in a multiplex reaction, allelic ladders for analysis of X-STR markers, and kits for the analysis of X-STR markers.

### PRIORITY AND RELATED APPLICATIONS

This application claims a priority benefit under 35 U.S.C. §119(e) from U.S. Patent Application No. 61/327,073, filed Apr. 22, 2011, which is incorporated herein by reference.

### FIELD

Embodiments of the present teachings are in the fields of the forensic analysis and the genealogy study of nucleic acid.

### BACKGROUND

Due to hemizygosity and a lack of recombination of the X chromosome in males, X-STR typing has been demonstrated in forensic practice to be a powerful tool for deficiency paternity testing and complex cases of kinship testing. The determination of kinship can be done using X-STR typing when only remote relatives are available, when the disputed child is female, in cases involving close blood relatives as alternative alleged fathers, or for maternity testing of male children. Additionally, typing of X-STRs can effectively complement autosomal STR analysis in identifying female traces in high male background such as female skin debris found in male fingernails. Further, population genetics data for numerous X-STR loci have been reported in certain ethnic groups. The typing of chromosome X alleles can assign pedigree members over long distances with respect to X-chromosomal tracks such as rejoining families in the context of war and world-wide migration, identification of the victims of war and mass disasters.

Disclosed is a multiplex X-STR assay, new alleles within X-STR loci and kits having an increased discriminatory capacity over existing X-STR kits. Thus, there still exists a need in the art for an X-STR assay with greater discriminatory capacity over existing commercial X-STR kits.

### SUMMARY OF SOME EMBODIMENTS

Certain embodiments of the present teachings include methods of identifying an individual by determining the allele of at least 4 X-STR markers selected from the group consisting of the X-STR markers: DXS101, DXS6789, DXS6797, DXS6800, DXS6807, DXS6810, DXS7132, DXS7133, DXS7423, DXS7424, DXS8377, DXS8378, DXS981, DXS9895, DXS9898, DXS9902, GATA165B12, GATA172D05, GATA31E08, and HPRTB. In some embodiments of the subject methods, the alleles can be identified by PCR. In some embodiments of the subject methods, the alleles can be identified by mass spectroscopy. The PCR can be multiplexed PCR so as to co-amplify the at least 4 X-STR markers. Certain embodiments of the present teachings include a set of amplification primer pairs comprising primers for the amplification of at least 4 X-STR markers selected from the group consisting of DXS101, DXS6789, DXS6797, XS6800, DXS6807, DXS6810, DXS7132, DXS7133, DXS7423, DXS7424, DXS8377, DXS8378, DXS981, DXS9895, DXS9898, DXS9902, GATA165B12, GATA172D05, GATA31E08, and HPRTB. The primer set can co-amplify at least 4-20 X-STR markers. In certain embodiments the primer set can co-amplify autosomal STR markers in addition to X-STR markers. In some embodiments, the autosomal STRs can be selected from the group consisting of D3S1358, vWA, FGA, D8S1179, D21S11, D18S51, D5S818, D13S317, D7S820, D16S539, THOI, TPDX, and CSFIPO. In some embodiments the primers can be labeled with a fluorescent dye. Other embodiments provided are allelic ladder size standard for calling one or more alleles of an STR from at least 4 of the X-STR markers selected from the group consisting of DXS101, DXS6789, DXS6797, DXS6800, DXS6807, DXS6810, DXS7132, DXS7133, DXS7423, DXS7424, DXS8377, DXS8378, DXS981, DXS9895, DXS9898, DXS9902, GATA165B12, GATA172D05, GATA31 E08, and HPRTB. Other embodiments provided are kits for identifying the alleles of at least 4 X chromosome STR markers, wherein the 4 markers are selected from the group consisting of DXS101, DXS6789, DXS6797, DXS6800, DXS6807, DXS6810, DXS7132, DXS7133, DXS7423, DXS7424, DXS8377, XS8378, DXS981, DXS9895, DXS9898, DXS9902, GATA165B12, GATA172D05, GATA31E08, and HPRTB, the kit comprising primers for the amplification of at least 4 X-STR markers, and an allelic ladder representative of the selected markers.

### BRIEF DESCRIPTION OF THE DRAWINGS

FIG. 1 is a display of the X-STR migrations and dye configurations for a 20-plex X-STR typing assay.

FIG. 2 is an electropherogram of 1 ng female DNA assayed with the 20-plex X-STR typing assay.

FIG. 3 is an electropherogram of 1 ng male DNA assayed with the 20-plex X-STR typing assay.

FIG. 4 is a schematic that depicts the subject X-STR markers location on the X chromosome.

FIG. 5 is a schematic that depicts the known linkage groups of X-STR markers on the X chromosome.

FIG. 6A and FIG. 6B are tables of the allele frequencies of the subject X-STR markers as determined from the 450 samples evaluated.

FIG. 7 is a list of formula used for calculation of the forensic efficiency of the subject X-STR markers.

FIG. 8 is a table of the calculated forensic efficiency parameters for the subject X-STR markers.

### DEFINITIONS

For the purposes of interpreting of this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used). It is noted that, as used in this specification and the appended claims, the singular forms “a,” “an,” and “the,” include plural referents unless expressly and unequivocally limited to one referent. The use of “or” means “and/or” unless stated otherwise. For illustration purposes, but not as a limitation, “X and/or Y” can mean “X” or “Y” or “X and Y”. The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of”. The term “and/or” means one or all of the listed elements or a combination of any two or more of the listed element.

The section headings used herein are for organizational purposes only and are not to be construed as limiting the described subject matter in any way. All literature cited in this specification, including but not limited to, patents, patent applications, articles, books, and treatises are expressly incorporated by reference in their entirety for any purpose. In the event that any of the incorporated literature contradicts any term defined herein, this specification controls. While the present teachings are described in conjunction with various embodiments, it is not intended that the present teachings be limited to such embodiments. On the contrary, the present teachings encompass various alternatives, modifications, and equivalents, as will be appreciated by those of skill in the art.

The practice of the present teachings may employ conventional techniques and descriptions of organic chemistry, polymer technology, molecular biology (including recombinant techniques), cell biology, biochemistry, and immunology, which are within the skill of the art. Such conventional techniques include oligonucleotide synthesis, hybridization, extension reaction, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), PCR Primer: A Laboratory Manual, and Molecular Cloning: A Laboratory Manual (all from Cold Spring Harbor Laboratory Press, 1989), Gait, “Oligonucleotide Synthesis: A Practical Approach” 1984, IRL Press, London, Nelson and Cox (2000), Lehninger, Principles of Biochemistry 3^{rd} Ed., W. H. Freeman Pub., New York, N.Y. and Berg et al. (2002) Biochemistry, 5th Ed., W. H. Freeman Pub., New York, N.Y. all of which are herein incorporated in their entirety by reference for all purposes.

The term “allele” as used herein refers to a genetic variation associated with a gene or a segment of DNA, i.e., one of two or more alternate forms of a DNA sequence occupying the same locus.

The term “allelic ladder” as used herein refers to a nucleic acid size standard that comprises size standards for one or more alleles for a particular STR marker. The allelic ladder serves as a reference standard and nucleic acid size marker for the amplified alleles from the locus. In some embodiments, the allelic ladder can comprise size standards for the alleles of different STRs. In some embodiments, the allelic ladder can be made of DNA. In some embodiments the allelic ladder can be made of non-naturally occurring nucleic acid analogs. The different individual size standards within an allelic ladder can, in some embodiments, be labeled with a detectable label, e.g., a fluorophore. In some embodiments, the allelic ladder components are labeled with the same fluorophore. In some embodiments, the allelic ladder components are labeled with different fluorophores. The size standards can be selected to work for a specific pair (or pairs) of oligonucleotides primers. For example if a first set of primers for marker X with a tetranucleotide repeat produces a 150 base pair amplicon corresponding to allele 7, the corresponding allelic ladder component will serve as a size standard for the 150 base amplicons; while a second pair of primers for marker X produces a 154 base pair amplicon corresponding to allele 8, the corresponding allelic ladder component will serve as a size standard for the 154 base amplicons. Thus different size standards for different size amplicons of the same marker are contemplated. The size standard for a given amplicon derived from a given allele may have nucleic acid base sequence that is the same or different than the nucleic acid base sequence of the amplicon or allele from which the amplicon is derived. For allele analysis in electrophoresis systems the size standard can be selected so as to have the same electropheretic mobility as the amplicon of interest. Alternatively, in some embodiments, the size standard can be selected so as to have different electropheretic mobility than the amplicon of interest, given an understanding of the predicable nature of the difference, the identity of the amplicons could be determined. For allele analysis in mass spectroscopy systems the size standard (weight/charge ratio, not electropheretic mobility) can be selected so as to have the same signal as the amplicon of interest. Alternatively, in some embodiments, the size standard (weight/charge ratio, not electropheretic mobility) can be selected so as to have the different separation properties than the amplicon of interest, given an understanding of the predicable nature of the difference, the identity of the amplicons could be determined.

The term “allelic variant” as used herein refers to the variation between two or more alleles within a locus. The allelic variant can also be referred to as a polymorphism.

The terms “amplicon,” “amplification product” and “amplified sequence” are used interchangeably herein and refer to a broad range of techniques for increasing polynucleotide sequences, either linearly or exponentially and can be the product of an amplification reaction. An amplicon can be double-stranded or single-stranded, and can include the separated component strands obtained by denaturing a double-stranded amplification product. In certain embodiments, the amplicon of one amplification cycle can serve as a template in a subsequent amplification cycle. Exemplary amplification techniques include, but are not limited to, PCR or any other method employing a primer extension step. Other nonlimiting examples of amplification include, but are not limited to, ligase detection reaction (LDR) and ligase chain reaction (LCR). Amplification methods can comprise thermal-cycling or can be performed isothermally. In various embodiments, the term “amplification product” and “amplified sequence” includes products from any number of cycles of amplification reactions.

As used herein, “amplify” refers to the process of enzymatically increasing the amount of a specific nucleotide sequence. This amplification is not limited to but is generally accomplished by PCR. As used herein, “denaturation” refers to the separation of two complementary nucleotide strands from an annealed state. Denaturation can be induced by a number of factors, such as, for example, ionic strength of the buffer, temperature, or chemicals that disrupt base pairing interactions. As used herein, “annealing” refers to the specific interaction between strands of nucleotides wherein the strands bind to one another substantially based on complementarity between the strands as determined by Watson-Crick base pairing. It is not necessary that complementarity be 100% for annealing to occur. As used herein, “extension” refers to the amplification cycle after the primer oligonucleotide and target nucleic acid have annealed to one another, wherein the polymerase enzyme catalyzes primer extension, thereby enabling amplification, using the target nucleic acid as a replication template.

As used herein, the term “base pair motif” refers to the nucleobase sequence configuration including, but not limited to, a repetitive sequence, a sequence with a biological significance, a tandem repeat sequence, and so on.

As used herein, the term “comparing” broadly refers to differences between two or more nucleic acid sequences. The similarity or differences can be determined by a variety of methods, including but not limited to: nucleic acid sequencing, alignment of sequencing reads, gel electrophoresis, restriction enzyme digests, single strand conformational polymorphism, and so on.

The terms “detecting” and “detection” are used in a broad sense herein and encompass any technique by which one can determine the presence of or identify a nucleic acid sequence. In some embodiments, detecting comprises quantitating a detectable signal from the nucleic acid, including without limitation, a real-time detection method, such as quantitative PCR (“Q-PCR”). In some embodiments, detecting comprises determining the sequence of a sequencing product or a family of sequencing products generated using an amplification product as the template; in some embodiments, such detecting comprises obtaining the sequence of a family of sequencing products. In other embodiments detecting can be achieved through measuring the size of a nucleic acid amplification product.

As used herein, “DNA” refers to deoxyribonucleic acid in its various forms as understood in the art, such as genomic DNA, cDNA, isolated nucleic acid molecules, vector DNA, and chromosomal DNA. “Nucleic acid” refers to DNA or RNA in any form. Examples of isolated nucleic acid molecules include, but are not limited to, recombinant DNA molecules contained in a vector, recombinant DNA molecules maintained in a heterologous host cell, partially or substantially purified nucleic acid molecules, and synthetic DNA molecules. A nucleic acid target is generally substantially free of other cellular material or culture medium when produced by recombinant techniques, or free of chemical precursors or other chemicals when chemically synthesized, or free of chemicals or materials that could interfere with downstream analyses of a target nucleic acid.

As used herein, “DXS9895, and presumable new alleles: allele-14.2 and allele-18.1” refers to the STR marker DXS9895 located at the DXS9895 locus on chromosome X, at Xp.22.32. Information on X-STR markers can be found on the ChrX-STR.org 2.0 website, xdb.qualitype.de/xdb. When reference is made to DXS9895, allele-14.2 and allele-18.1, envisioned too are possible incomplete, variable and imperfect repeats of DXS9895, allele-14.2 and allele-18.1.

As used herein, “DXS9902, and presumable new alleles: allele-6 and allele-6.2,” refers to the STR marker DXS9902 located at the DXS9902 locus on chromosome X at Xp.22.20. When reference is made to DXS9902, allele-6 and allele-6.2, envisioned too are possible incomplete, variable and imperfect repeats of DXS9902.

As used herein, “DXS6810, allele-21” refers to the STR marker DXS6810 located at the DXS6810 locus on chromosome X, at Xp.11.30. The allele repeat structure is presumed to be -(CTGT)₁-(CTAT)₂-(CTGT)₂-(CTAT)₁₁₋₁₄ -CAT-(CTAT)₁-, (SEQ ID NO:1) with a possible additional CTAT₁₅ repeat (SEQ ID NO:2). When reference is made to DXS6810, allele-21, envisioned too are possible incomplete, variable and imperfect repeats of DXS6810, allele-21.

As used herein, “DXS7132, and presumed new alleles: allele-13.3, allele-15.3 and allele-16.3” refers to the STR marker DXS7132 located at the DXS7132 locus on chromosome X, at Xc, part of linkage group 2. The allele repeat structure is presumed to be (TCTA)₁₁₋₁₇. When reference is made to DXS7132, allele-13.3, allele-15.3 and allele-16.3, envisioned too are possible incomplete, variable and imperfect repeats of DXS7132, allele-13.3, allele-15.3 and allele-16.3.

As used herein, “DXS981, allele-10” refers to the STR marker DXS981 located at the DXS981 locus on chromosome X, at Xq13.10. When reference is made to DXS981, allele-10, envisioned too are possible incomplete, variable and imperfect repeats of DXS981, allele-10.

As used herein, “DXS6800, allele-22.3” refers to the STR marker DXS6800 located at the DXS6800 locus on chromosome X, at Xq 13.30. When reference is made to DXS6800, allele-22.3, envisioned too are possible incomplete, variable and imperfect repeats of DXS6800, allele-22.3.

As used herein, “DXS9898, and presumed new alleles: allele-12.3 and allele-13.3 refers to the STR marker DXS9898 located at the DXS9898 locus on chromosome X, at Xq 21.31. When reference is made to DXS9898, allele-12.3 and allele-13.3, envisioned too are possible incomplete, variable and imperfect repeats of DXS9898, allele-12.3 and allele-13.3.

As used herein, “GATA31 E08, allele-7.1” refers to the STR marker GATA31E08 located at the GATA31E08 locus on chromosome X, at Xq 27.10. The allele-7 repeat structure is presumed to be [AGAT]₇. When reference is made to GATA31E08, allele-7.1, envisioned too are possible incomplete, variable and imperfect repeats of GATA31E08, allele-7.1.

As used herein, the term “flanking sequence” broadly refers to nucleic acid sequence 5′ and/or 3′ of a target nucleic acid sequence, including, but not limited to, a short tandem repeat sequence as a target nucleic acid sequence. The flanking sequence can be within an amplification product or outside, i.e., flanking, the amplification product. Amplification primers can be selected to hybridize to sequences flanking the variable portion of an STR marker so as to produce amplicons of a size indicative of a specific allele of the STR marker

As used herein, the term “short tandem repeat (STR) loci” refers to regions of a genome which contains short, repetitive sequence elements of 2 to 7 base pairs in length. Each sequence element is repeated at least once within an STR and is referred to herein as a “repeat unit.” The term STR also encompasses a region of genomic DNA wherein more than a single repeat unit is repeated in tandem or with intervening bases, provided that at least one of the sequences is repeated at least two times in tandem. Examples of STRs, include but are not limited to, a triplet repeat, e.g., ATC in tandem, e.g., ATCATC; a 4-peat (tetra-repeat), e.g., GATA in tandem, e.g., GATAGATA; and a 5-peat (penta-repeat), e.g., ATTGC in tandem and so on. Information about specific STRs that can be used as genetic markers can be found in, among other places, the STRbase at www.cstl.nist.gov/strbase.

As used herein, the terms “imperfect repeat”, “incomplete repeat”, and “variant repeat” refer to a tandem repeat within which the repeat unit, though in tandem, has sequence interruptions (additions or deletions) between one or more repeat units, e.g., ATCG ATCG AACG ATCG ATCG (SEQ ID NO:3), where the third repeat unit is not identical to the other repeat units and so an imperfect repeat; an incomplete repeat can be seen as a tandem repeat in which the number of base pairs in a repeat unit is an incomplete repeat, e.g., allele 9 of the TH01 locus contains nine 4-peat repeat units ([AATG]₉ for the complete repeat “AATG” for the TH01 locus, but the 9.3 allele contains the nine “AATG” repeats and one incomplete repeat, “ATG” of three nucleotides, an incomplete repeat, i.e., [AATG]₆ATG[AATG]₃ (SEQ ID NO:4); while a variant repeat has variation(s) within the repeat unit, e.g., ATCC ATCG ATCC ATCG ATCG ATCC ATCC (SEQ ID NO:5), where the 4-peat repeat unit has a variant base pair at the fourth position of the repeat unit, either a “C” or a “G” nucleotide.

“Genetic markers” are generally alleles of genomic DNA loci with characteristics of interest for analysis, such as DNA typing, in which individuals are differentiated based on variations in their DNA. Most DNA typing methods are designed to detect and analyze differences in the length and/or sequence of one or more regions of DNA markers known to appear in at least two different forms, or alleles, in a population. Such variation is referred to as “polymorphism,” and any region of DNA in which such a variation occurs is referred to as a “polymorphic locus.” One possible method of performing DNA typing involves the joining of PCR amplification technology (K B Mullis, U.S. Pat. No. 4,683,202) with the analysis of length variation polymorphisms. PCR traditionally could only be used to amplify relatively small DNA segments reliably; i.e., only amplifying DNA segments under 3,000 bases in length (M. Ponce and L. Micol (1992), NAR 20(3):623; R. Decorte et al. (1990), DNA CELL BIOL. 9(6):461 469). Short tandem repeats (STRs), minisatellites and variable number of tandem repeats (VNTRs) are some examples of length variation polymorphisms. DNA segments containing minisatellites or VNTRs are generally too long to be amplified reliably by PCR. By contrast STRs, containing repeat units of approximately three to seven nucleotides, are short enough to be useful as genetic markers in PCR applications, because amplification protocols can be designed to produce smaller products than are possible from the other variable length regions of DNA.

The term “locus” as used herein refers to a specific position on a chromosome or a nucleic acid molecule. Alleles of a locus are located at identical sites on homologous chromosomes. “Loci” is the plural of locus and as used herein refers to a plurality of positions on either a single or multiple chromosomes or nucleic acid molecules.

As used herein, the term “mobility modifier” refers to a non-nucleotide linker between a dye attached to the 5′ end of a PCR primer and the PCR primer's 5′ end. Examples of mobility modifiers include, but are not limited to, oligo ethylene oxide mobility modifiers such as hexaethyleneoxide (HEO) (Grossman et al. NAR 22:2527-2534 (1994)), U.S. Pat. Nos. 5,470,705; 5,703,222 and 5,989,871. Examples of the use of mobility modifiers to assist in amplicon separation in the 20-plex taught herein are X-STR markers DSX8377, DXS981, DXS6810, and GATA31E08.

A “mutation” in an X-STR marker is a change in the length of the repeat region of an STR marker or a change in the length (i.e., number) of the bases that are interspersed with the repeat units. For example, the addition of one more repeat unit is a mutation resulting in the appearance of a new allele. In another example, the addition of a single base within a single repeat unit is also a mutation resulting in the appearance of a new allele. Such changes can result form the addition or deletion of one or more repeat units (or fractions thereof). Such sequence changes are readily detected by methods of analysis that are capable of detecting variations in nucleic acid sequence length or nucleic acid base order.

As used herein, the term “nucleic acid sample” refers to nucleic acid found in a biological source, for example. “Sample” as used herein, is used in its broadest sense and refers to a sample suspected of containing a nucleic acid and can comprise a cell, chromosomes isolated from a cell (e.g., a spread of metaphase chromosomes), genomic DNA, RNA, cDNA and the like. Samples can be of animal, prokaryotic, synthetic or vegetable origins encompassing any organism containing nucleic acid, including, but not limited to, cloned, synthetic constructs, bacteria, viruses, plants, livestock, household pets, and human samples. Accordingly, as used herein, the term “nucleic acid sample” may refer to nucleic acid found in biological sources according to the present teachings including, but not limited to, for example, hair, feces, blood, tissue, urine, saliva, cheek cells, vaginal cells, skin, for example skin cells contained in fingerprints, bone, tooth, buccal sample, amniotic fluid containing placental cells, and amniotic fluid containing fetal cells and semen. It is contemplated that samples may be collected invasively or noninvasively. In addition from originating from a biological source, a nucleic acid sample can be on, in, within, from or found in conjunction with for example, but not limited by a fiber, fabric, cigarette, chewing gum, adhesive material, soil and inanimate objects.

As used herein, the term “polymorphic short tandem repeat loci” refers to STR loci in which the number of repetitive sequence elements (and net length of the sequence) in a particular region of genomic DNA varies from allele to allele, and from individual to individual.

As used herein, the terms “polynucleotide”, “oligonucleotide”, and “nucleic acid” are used interchangeably herein and refer to single-stranded and double-stranded polymers of nucleotide monomers, including without limitation 2′-deoxyribonucleotides (DNA) and ribonucleotides (RNA) linked by internucleotide phosphodiester bond linkages, or internucleotide analogs, and associated counter ions, e.g., H⁺, NH₄⁺, trialkylammonium, Mg²⁺, Na⁺, and the like. A polynucleotide may be composed entirely of deoxyribonucleotides, entirely of ribonucleotides, or chimeric mixtures thereof and can include nucleotide analogs. The nucleotide monomer units may comprise any nucleotide or nucleotide analog. Polynucleotides typically range in size from a few monomeric units, e.g. 5-40 when they are sometimes referred to in the art as oligonucleotides, to several thousands of monomeric nucleotide units. Unless denoted otherwise, whenever a polynucleotide sequence is represented, it will be understood that the nucleotides are in 5′ to 3′ order from left to right and that “A” denotes deoxyadenosine, “C” denotes deoxycytosine, “G” denotes deoxyguanosine, “T” denotes thymidine, and “U” denotes deoxyuridine, unless otherwise noted.

As used herein, the terms “target polynucleotide,” “nucleic acid target” and “target nucleic acid” are used interchangeably herein and refer to a particular nucleic acid sequence of interest. The “target” can be a polynucleotide sequence that is sought to be amplified and can exist in the presence of other nucleic acid molecules or within a larger nucleic acid molecule. The target polynucleotide can be obtained from any source, and can comprise any number of different compositional components. For example, the target can be nucleic acid (e.g. DNA or RNA). The target can be methylated, non-methylated, or both. Further, it will be appreciated that “target polynucleotide” can refer to the target polynucleotide itself, as well as surrogates thereof, for example amplification products, and native sequences. The target polynucleotides of the present teachings can be derived from any of a number of sources. These sources may include, but are not limited to, whole blood, a tissue biopsy, lymph, bone, bone marrow, tooth, amniotic fluid, hair, skin, semen, anal secretions, vaginal secretions, perspiration, saliva, buccal swabs, various environmental samples (for example, agricultural, water, and soil), research samples generally, purified samples generally, and lysed cells. In some embodiments, the target polynucleotide is a short DNA molecule derived from a degraded polynucleotide molecule, such as can be found in, for example, but not limited to, forensics samples (see for example Butler, 2001, Forensic DNA Typing: Biology and Technology Behind STR Markers). It will be appreciated that nucleic acid samples containing target polynucleotide sequences can be isolated from samples using any of a variety of sample preparation procedures known in the art, for example, including the use of such procedures as, but not limited by, filtration, extraction, mechanical force, sonication, and restriction endonuclease cleavage.

As used herein, the “polymerase chain reaction” or PCR is a an amplification of nucleic acid consisting of an initial denaturation step which separates the strands of a double stranded nucleic acid sample, followed by repetition of (i) an annealing step, which allows amplification primers to anneal specifically to positions flanking a target sequence; (ii) an extension step which extends the primers in a 5′ to 3′ direction thereby forming an amplicon polynucleotide complementary to the target sequence, and (iii) a denaturation step which causes the separation of the amplicon from the target sequence (Mullis et al., eds, The Polymerase Chain Reaction, BirkHauser, Boston, Mass. (1994)). Each of the above steps may be conducted at a different temperature, preferably using an automated thermocycler (Applied Biosystems LLC, a division of Life Technologies Corporation, Foster City, Calif.). If desired, RNA samples can be converted to DNA/RNA heteroduplexes or to duplex cDNA by methods known to one of skill in the art. The PCR method also includes reverse transcriptase-PCR and other reactions that follow principles of PCR.

The term “primer” refers to a polynucleotide (oligonucleotide) and analogs thereof that are capable of selectively hybridizing to a target nucleic acid or “template”, a target region flanking sequence or to a corresponding primer-binding site of an amplification product; and allows the synthesis of a sequence complementary to the corresponding polynucleotide template, flanking sequence or amplification product from the primer's 3′ end. Typically a primer can be between about 10 to 100 nucleotides in length and can provide a point of initiation for template-directed synthesis of a polynucleotide complementary to the template, which can take place in the presence of appropriate enzyme(s), cofactors, substrates such as nucleotides (dNTPs) and the like.

As used herein, the terms “amplification primer” and “oligonucleotide primer” are used interchangeably and refer to an oligonucleotide, capable of annealing to an RNA or DNA region adjacent a target sequence, and serving as an initiation primer for DNA synthesis under suitable conditions well known in the art. Typically, a PCR reaction employs an “amplification primer pair” also referred to as an “oligonucleotide primer pair” including an “upstream” or “forward” primer and a “downstream” or “reverse” primer, which delimit a region of the RNA or DNA to be amplified. A first primer and a second primer may be either a forward or reverse primer and are used interchangeably herein and are not to be limiting.

As used herein, the term “primer-binding site” refers to a region of a polynucleotide sequence, typically a sequence flanking a target region and/or an amplicon that can serve directly, or by virtue of its complement, as the template upon which a primer can anneal for any suitable primer extension reaction known in the art, for example, but not limited to, PCR. It will be appreciated by those of skill in the art that when two primer-binding sites are present on a double-stranded polynucleotide, the orientation of the two primer-binding sites is generally different. For example, one primer of a primer pair is complementary to and can hybridize with the first primer-binding site, while the corresponding primer of the primer pair is designed to hybridize with the complement of the second primer-binding site. Stated another way, in some embodiments the first primer-binding site can be in a sense orientation, and the second primer-binding site can be in an antisense orientation. A primer-binding site of an amplicon may, but need not comprise the same sequence as or at least some of the sequence of the target flanking sequence or its complement.

Those in the art understand that as a target region is amplified by certain amplification means, the complement of the primer-binding site is synthesized in the complementary amplicon or the complementary strand of the amplicon. Thus, it is to be understood that the complement of a primer-binding site is expressly included within the intended meaning of the term primer-binding site, as used herein.

As used herein, the term “tandem repeat” refers to a repetitive sequence occurring in sequential succession.

As used herein, the term “tandem repeat locus” refers to a locus containing tandem repeats.

Also herein, the recitations of numerical ranges by endpoints include all numbers subsumed within that range (e.g., 1 to 5 includes 1, 1.5, 2, 2.75, 3, 3.80, 4, 5, etc.).

Unless defined otherwise, all technical and scientific terms used herein have the same meaning as is commonly understood by one of ordinary skill in the art to which these teachings belong. All patents, patent applications, published applications, treatises and other publications referred to herein, both supra and infra, are incorporated by reference in their entirety. If a definition and/or description is set forth herein that is contrary to or otherwise inconsistent with any definition set forth in the patents, patent applications, published applications, and other publications that are herein incorporated by reference, the definition and/or description set forth herein prevails over the definition that is incorporated by reference. The citation of any publication is for its disclosure prior to the filing date and should not be construed as an admission that the present teachings are not entitled to antedate such publication by virtue of prior disclosure.

### DESCRIPTION OF CERTAIN EXEMPLARY EMBODIMENTS

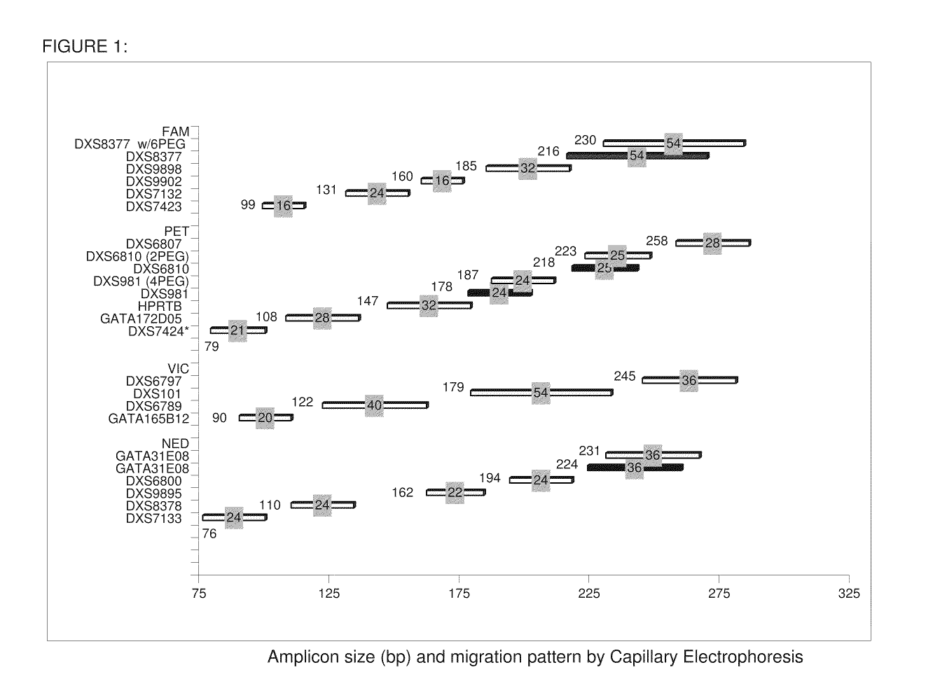

Applicants have evaluated numerous X-STR markers to design a multiplex 20-plex X-STR assay with greater discrimination than currently available commercial assays. In the process, Applicants have also discovered, in eight of the 20 X-STR markers, 13 potentially new alleles that were not previously known to exist in the eight X-STR markers. The 20 X-STR markers used in the highly discriminatory assay are: DXS101, DXS6789, DXS6797, DXS6800, DXS6807, DXS8378, DXS6810, DXS7132, DXS7133, DXS7423, DXS7424, DXS8377, DXS981, DXS9895, DXS9898, DXS9902, GATA165B12, GATA172D05, GATA31E08, and HPRTB. The eight X-STR markers that have the newly identified alleles were: DXS9895, DXS9902, DXS6810, DXS7132, DXS981, DXS6800, DXS9898, and GATA31E08. FIG. 1 illustrates the clear separation and a four-color dye scheme for distinguishing the 20 X-STR markers by capillary electrophoresis. The number to the left of the bar represents the mobility of the smallest allele in each X-STR while the numbers in the middle of the bar corresponds to the length of the repeat region. The length of the repeat region is based on the number of alleles times their separation. For example, DXS101 starts at 179 bp and because it is a trinucleotide repeat marker its length is 54 bp (18 alleles ×3 bp separation).

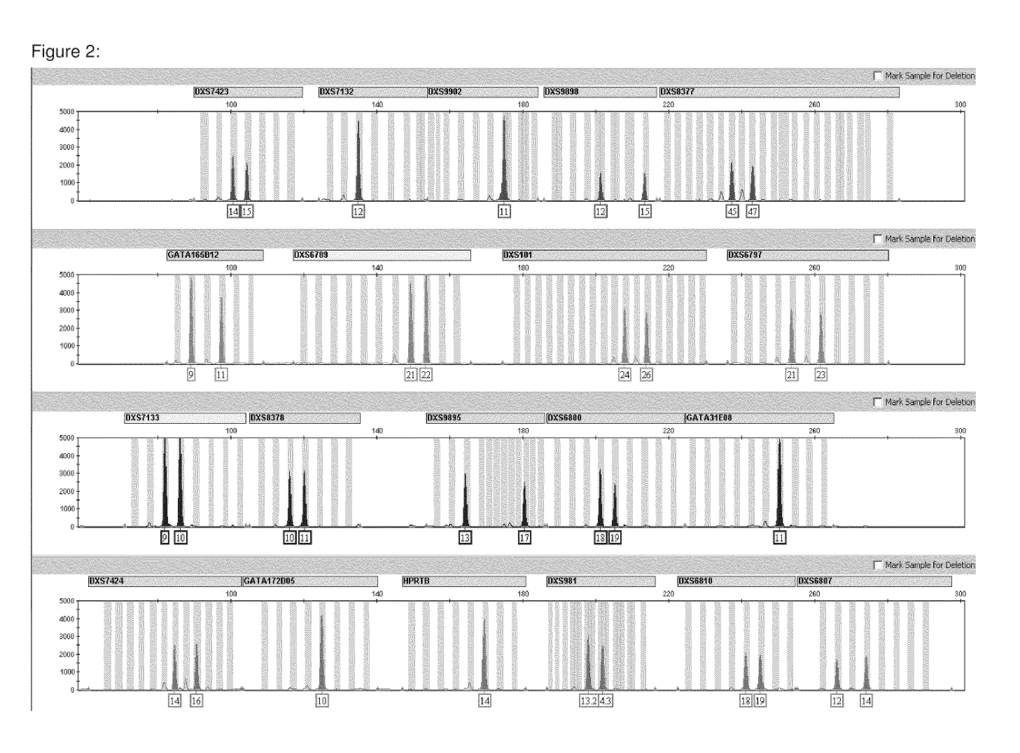

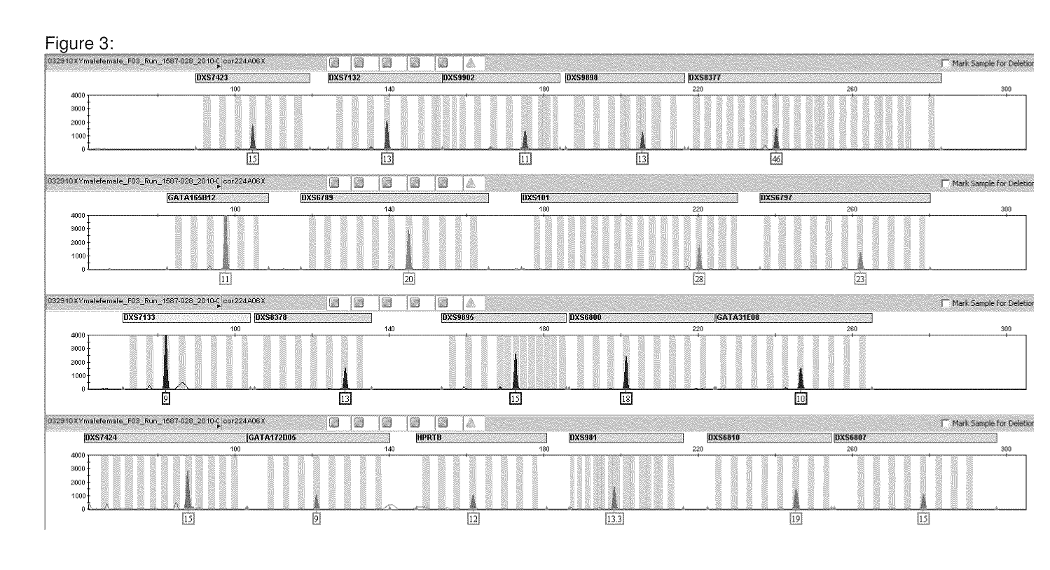

Males have only a single X chromosome and so recombination within the male genome is highly unlikely in the X chromosome whereas in the female genome, recombination between X-STR markers can be used to determine haplotypes as well as distinguish two females having the same father. X-STR markers are equally able to distinguish mother-son kinship as in father/daughter tests. Likewise, if alleged fathers are father and son, they would not share X-STR alleles since different mothers contributed a different X chromosome to the father and to the son. FIGS. 2 and 3 provide allele detection results for the 20-plex assay in 1 ng of DNA for a female sample (FIG. 2) and a male sample (FIG. 3).

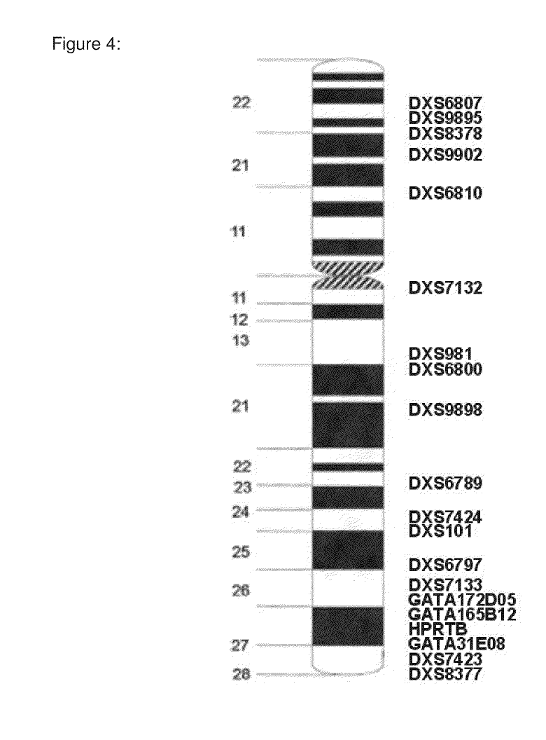

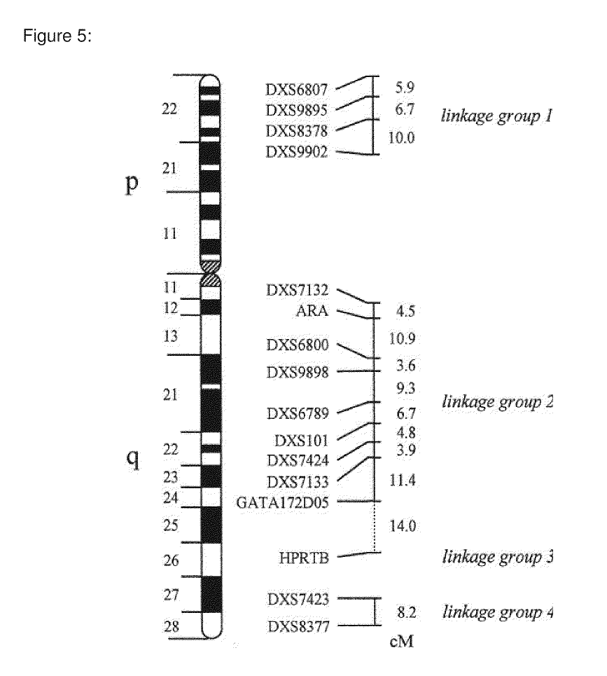

These X-STR markers with collectively improved discrimination power permit the increased likelihood of distinguishing between female members of the same genetic lineage. The likelihood of discrimination between members of the same male lineage is even greater when multiple X-STR markers are employed. Various embodiments of the present teachings provided herein include methods, reagents, and kits for determining the specific allele of one or more of the subject X-STR markers in a given sample for analysis. As seen in FIG. 4, the 20 X-STR markers cover much of the entire length of the X chromosome as well as the four known linkage regions within the X chromosome, as illustrated in FIG. 5. The four linkage regions are useful for haplotype determinations. Linkage disequilibrium test results for the 20 X-STR markers are provided in Table 1, further illustrating the power of the 20-plex.

TABLE 1

| Locus Combination | p-value |
|---|---|
| DXS6807-DXS8378-DXS9895 | 0.130 |
| DXS8378-DXS9895-DXS9902 | 0.012 |
| DXS9895-DXS9902-DXS6810 | 0.025 |
| DXS9902-DXS6810-DXS7132 | 0.108 |
| DXS6810-DXS7132-DXS981 | 0.193 |
| DXS7132-DXS981-DXS6800 | 0.522 |
| DXS981-DXS6800-DXS9898 | 0.112 |
| DXS6800-DXS9898-DXS6789 | 0.152 |
| DXS9898-DXS6789-DXS7424 | 0.239 |
| DXS6789-DXS7424-DXS101 | 0.000 |
| DXS7424-DXS101-DXS6797 | 0.000 |
| DXS101-DXS6797-DXS7133 | 0.001 |
| DXS6797-DXS7133-GATA172D05 | 0.006 |
| DXS7133-GATA172D05-GATA165B12 | 0.112 |
| GATA172D05-GATA165B12-HPRTB | 0.091 |
| GATA165B12-HPRTB-GATA31E08 | 0.024 |
| HPRTB-GATA31E08-DXS7423 | 0.379 |
| GATA31E08-DXS7423-DXS8377 | 0.173 |

By evaluation of 450 anonymous, unrelated U.S. residents comprising the DNA Polymorphism Discovery Resource Panel (DPDRP), Applicants were able to not only improve discrimination but identify new alleles in X-STRs which further assist in genotyping capabilities. The panel subjects have ancestors representing the major geographic regions of the world, i.e., Europe, Africa, the Americas and Asia and the panel has equal numbers of females and males. A breakdown of the panel is provided in Table 2.

TABLE 2

| | Proportion of | Number of |
|---|---|---|
| Population Group | Admixture | Individuals |
| European-American | 0.01 | 120 |
| African-American | 0.17 | 120 |
| Mexican-American | 0.39 | 60 |
| Native American | 0.05 | 30 |
| Asian-American | 0.10 | 120 |

| | |
|---|---|
| Total number of individuals | 450 |

Provided herein are various methods for determining the specific allele of one or more of the X-STR markers. The specific alleles of the X-STR markers can be determined using essentially the same methods and technologies that are used for the determination of alleles for other types of STR markers. Such methods and technologies can readily be adapted by the person skilled in the art so as to be suitable for use in the allele determination of the X-STR markers. Examples of such technologies include DNA sequencing and sequence specific amplification techniques such as PCR, used in conjunction with detection technologies such as electrophoresis, mass spectroscopy, and the like. In some embodiments, PCR amplification products may be detected by fluorescent dyes conjugated to the PCR amplification primers, for example as described in PCT patent application WO 2009/059049. PCR amplification products can also be detected by other techniques, including, but not limited to, the staining of amplification products, e.g. silver staining and the like. Examples I and II illustrate PCR reactions and thermal cycler conditions as would be known to one of skill in the art.

The specific allele of a given X-STR marker can also be determined by any of a variety of DNA sequencing techniques that are widely available, e.g., Sanger sequencing, pyrosequencing, Maxim and Gilbert sequencing, and the like. Numerous automated DNA sequencing techniques are commercially available, the Applied Biosystems 3130, the Applied Biosystems 3100, the Illumina Genome Analyzer, the Applied Biosystems SOLiD™ system, the Roche Genome Sequencer Flx system and the like.

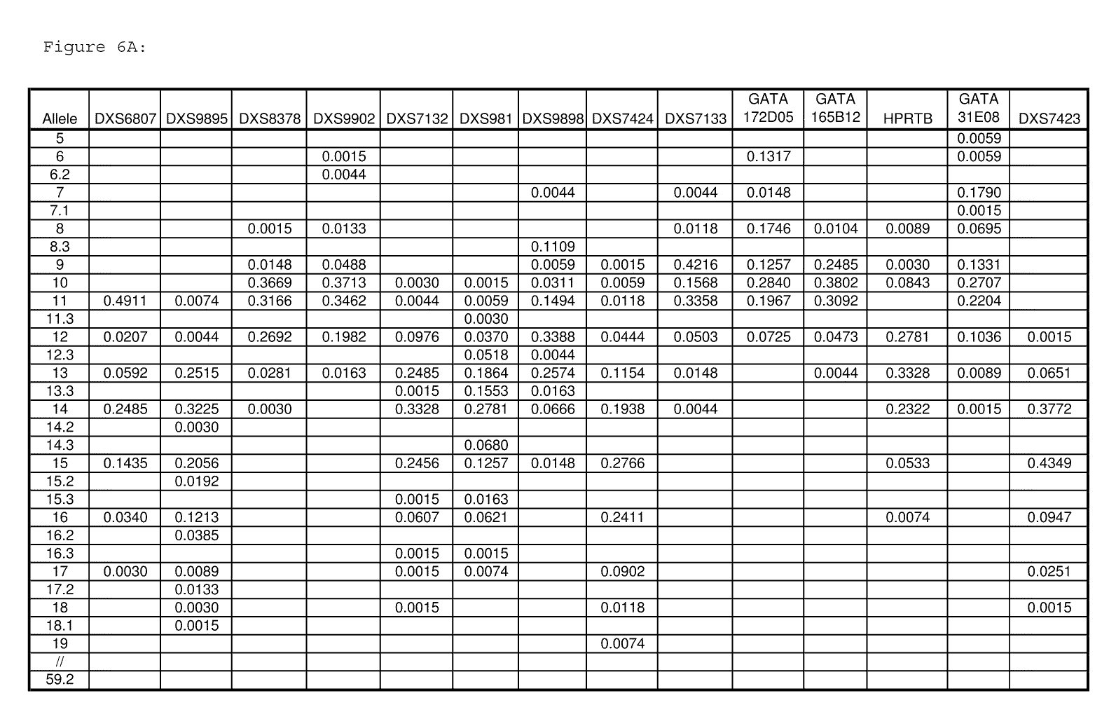

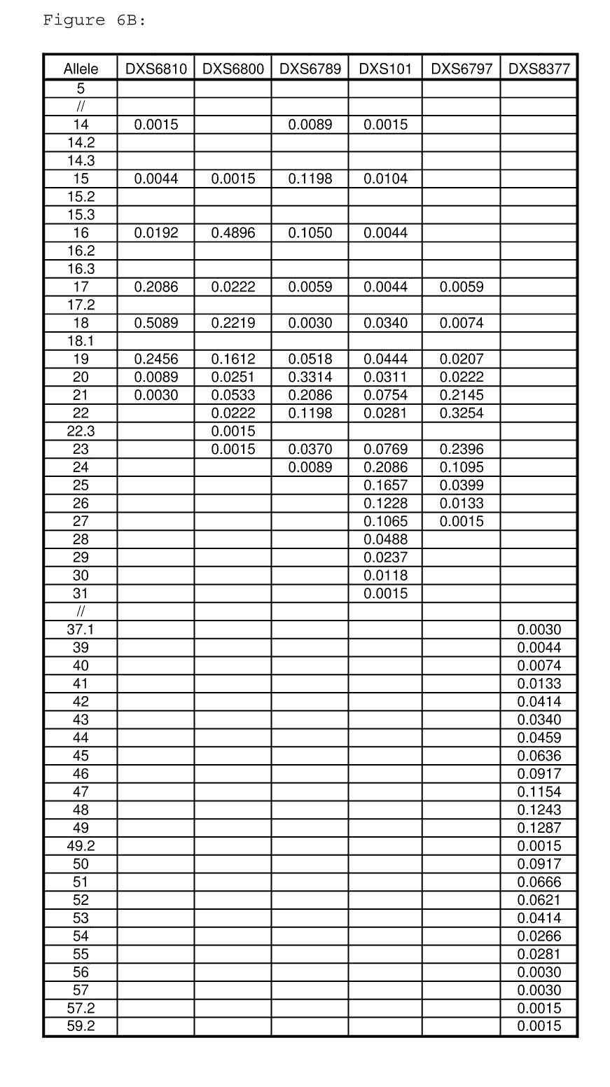

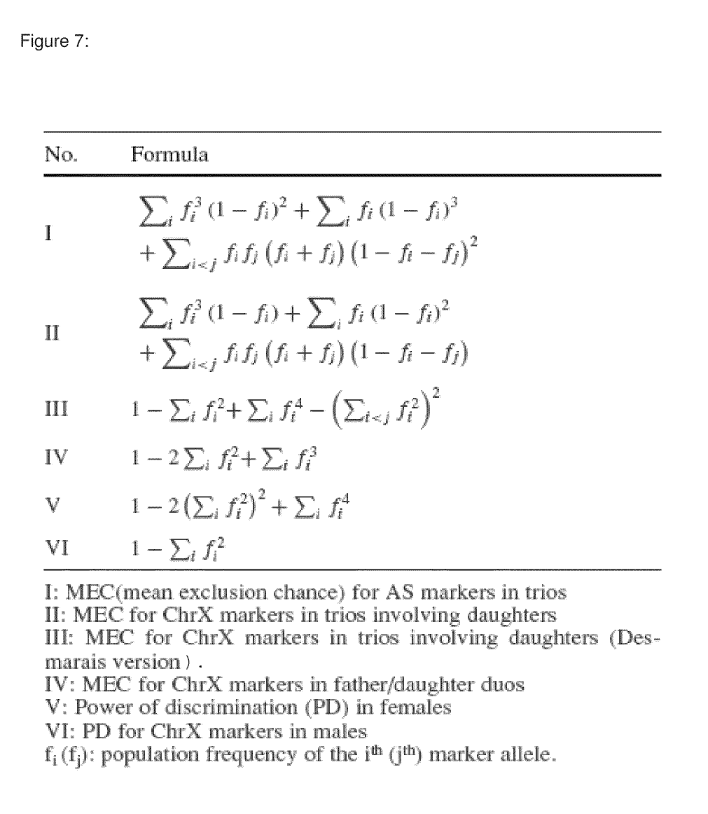

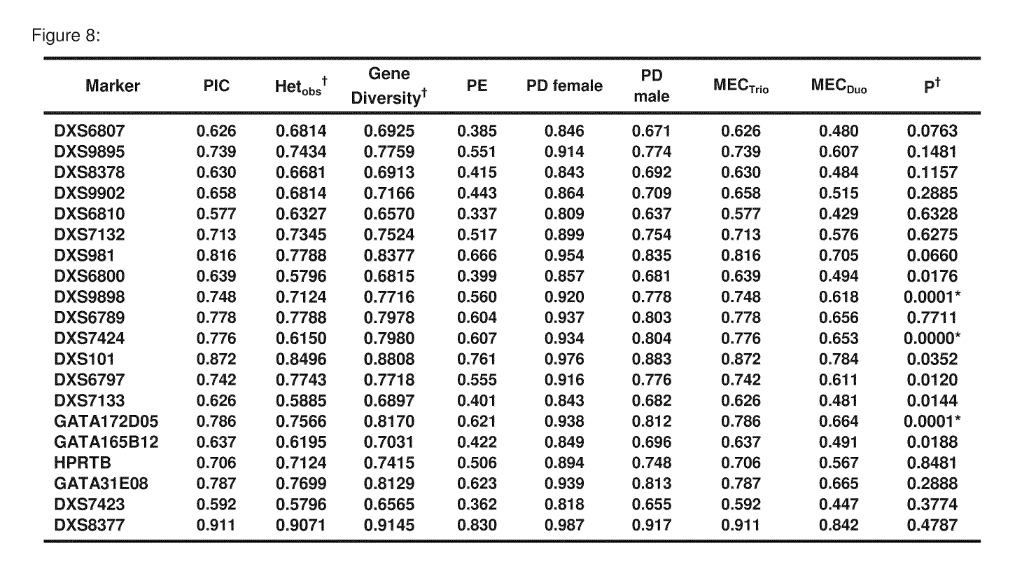

The 20-plex multiplex assay was able to provide allele frequencies for the 450 persons evaluated from the DPDRP as shown in FIGS. 6A and 6B. Using the formula found in FIG. 7, the power of discrimination (PD) in females and for Chromosome X markers in males was determined along with the polymorphism information content (PIC) as shown in FIG. 8.

DNA for analysis using the subject methods and compositions can be obtained from a variety of sources. DNA can be obtained at crime scenes, e.g., semen recovered from a rape victim, human remains, as well as blood. Additionally, DNA for analysis can be obtained directly from female and male subjects. X-STR analysis, like Y-STRs, can be used for the purpose of generating a database of allelic information (for subsequent analysis) or can be obtained from identified suspects.

DNA for analysis can be quantified prior to allelic analysis, thereby providing for more accurate allele calling. DNA quantity in a sample may be determined by many techniques known to the person skilled in the art, e.g., real-time PCR. It is of interest to quantitate the X chromosomal DNA present in a sample for analysis prior to performing allelic analysis for X-chromosomal STR markers, e.g., when sample is limited or when the female X contribution is minimal when compared to XY male contribution. Autosomal (AS) DNA in the sample may also be quantitated, thereby providing a method for determining the background amount of female DNA present in a mixed sample, such as those samples recovered in rape cases.

An X chromosomal haplotype can be established by determining the specific alleles present on a plurality of X-STR markers. In general, the more X-STR marker alleles determined for given sample, the more information that can be obtained and the greater the probability of detecting a mutation in one or more X-STR markers, thereby increasing the probability of being able to distinguish between male relatives based on X-chromosomal marker analysis. In some embodiments, the X-STR markers can be analyzed by a method employing multiplex PCR. Multiplex PCR can amplify 2, 3, 4, 5, 6, 7, 8, 9, 10, 11, 12, 13, 14, 15, 16, 17, 18, 19, or all 20 of the X-STR markers. In some embodiments, multiplex PCR can co-amplify additional X-STR markers that are not part of the set of the subject X-STR markers. In some embodiments, a multiplex PCR can provide for the co-amplification of one or more autosomal STR markers, e.g. the CODIS STR markers, D3S1358, vWA, FGA, D8S1179, D21S11, D18551, D5S818, D135317, D7S820, D16S539, THO1, TPDX, and CSF1PO. In some embodiments, the multiplex PCR can co-amplify with amelogenin oligonucleotide primers to assist in determination of the gender of the sample. Detailed descriptions for the development of multiplex PCR for STR analysis can be found, among other places in PCT patent application WO 2009/059049 A1. In some embodiments, the amplification product for each X-STR marker is 300 bp or less in length. In various embodiments the CODIS loci used in conjunction with the X-STR markers have amplification products of 300 bp or less. In some embodiments the PCR reactions are not multiplexed. The amplicons that are produced in non-multiplex PCR reactions can be combined prior to the analysis by an instrument, e.g. a fluorescent DNA fragment analyzer (such as an automated DNA sequencer) or a mass spectrometer. Mass spectroscopy of STR markers is described in, among other places, U.S. Pat. No. 6,090,558.

Other embodiments include sets of PCR primers for the co-amplification of at least two, at least three, and at least four or more X-STR markers. Embodiments include sets of PCR primers for the co-amplification of 2, 3, 4, 5, 6, 7, 8, 9, 10, 11, 12, 13, 14, 15, 16, 17, 18, 19, or 20 of the X-STR markers provided herein. In some embodiments, PCR primer sets can comprise primers for the co-amplification of the gender determining region, amelogenin. In some embodiments, the set of PCR primers can comprise PCR primers for the co-amplification of STR markers present on an AS.

The embodiments of the present teachings also include allelic ladders to aid in the identification of alleles of X-STR markers. The allelic ladders can comprise sets of size standards for 1, 2, 3, 4, 5, 6, 7, 8, 9, 10, 11, 12, 13, 14, 15, 16, 17, 18, 19, or 20 of the X-STR markers. For each marker present in the allelic ladder, the allelic ladder can comprise standards for one or more alleles. An allelic ladder can comprise size standards for all known alleles of a given X-STR marker, or any subset of known alleles. In some embodiments, the size standards in the allelic ladder can be labeled with one or more fluorescent dyes. In some embodiments of allelic ladder can further comprise size standards for AS STR markers and/or the amelogenin gender marker. In some embodiments of allelic ladder can further comprise size standards for X-STR markers that comprise the new alleles identified herein for the X-STR markers.

Other embodiments of the subject teachings include kits for the determination of the alleles for two or more, three or more, and four or more X-STR markers. Embodiments of the kits can comprise the subject loci sets and their amplification primers. In some embodiments the kits can comprise one or more reagents used in nucleic amplification reactions. Examples of such reagents include, but are not limited to, DNA polymerases, dNTPs, buffers, nucleic acid purification reagents and the like. In some embodiments, the kits can comprise an allelic ladder designed to act as a size standard for the X-STR marker alleles generated (or potentially generated) by amplification primers present in the kit. Thus, in some embodiments, the kits can comprise allelic ladders specifically adapted to the amplicons generated by the use of the kit primers in an amplification reaction. For example a kit comprising primers for co-amplifying X-STR markers DXS6807, DXS7132, GATA172D05, and GATA31E08, can also include an allelic ladder having size standards for various alleles of X-STR markers DXS6807, DXS7132, GATA172D05, and GATA31E08. The component size standards of an allelic ladder for given STR marker can be labeled with the same or different detectable labels, e.g., a fluorescent dye, as are the primers used to generate the amplicons of the actual allele in the sample for analysis.

The present teachings are also directed to kits for human identification that utilize the methods described above. In some embodiments, a basic kit can comprise a container having at least one pair of oligonucleotide primers for an X-STR marker listed in FIGS. 6A and 6B. A kit can also optionally comprise instructions for use. A kit can also comprise other optional kit components, such as, for example, one or more of an allelic ladder directed to each of the loci amplified, a sufficient quantity of enzyme for amplification, amplification buffer to facilitate the amplification, divalent cation solution to facilitate enzyme activity, dNTPs for strand extension during amplification, loading solution for preparation of the amplified material for electrophoresis, genomic DNA as a template control, a size marker to insure that materials migrate as anticipated in the separation medium, and a protocol and manual to educate the user and limit error in use. The amounts of the various reagents in the kits also can be varied depending upon a number of factors, such as the optimum sensitivity of the process. It is within the scope of these teachings to provide test kits for use in manual applications or test kits for use with automated sample preparation, reaction set-up, detectors or analyzers.

Those in the art understand that the detection techniques employed are generally not limiting. Rather, a wide variety of detection means are within the scope of the disclosed methods and kits, provided that they allow the presence or absence of an amplicon to be determined.

The present teachings can be better understood by reference to the following examples comprising experimental data. Such information is offered to be examples and is not intended to limit the scope of the disclosure as claimed.

### EXAMPLES

### I. PCR Sample Reaction Mix

The PCR amplification was performed in a PCR reaction containing 0.2-1.5 ng of DNA, 12.5 ul 2× AmpFISTR® Identifiler® Direct Reaction Mix (Applied Biosystems), 0.6 ul 25 mM MgCl₂ and primers, in a total volume of 25 ul. Primer concentrations are provided in Table 3:

TABLE 3

| | | concentration |
|---|---|---|
| | | range in PCR |
| Dye | Marker | (uM) |
| FAM | DXS7423 | 0.12-0.5 |
| | DXS7132 | 0.12-0.5 |
| | DXS9902 | 0.12-0.5 |
| | DXS9898 | 0.4-0.72 |
| | DXS8377 | 0.12-0.5 |
| VIC | GATA165B12 | 0.12-0.5 |
| | DXS6789 | 0.12-0.5 |
| | DXS101 | 0.12-0.5 |
| | DXS6797 | 0.12-0.5 |
| NED | DXS7133 | 0.12-0.5 |
| | DXS8378 | 0.12-0.5 |
| | DXS9895 | 0.12-0.5 |
| | DXS6800 | 0.12-0.5 |
| | GATA31E08 | 0.12-0.5 |
| PET | DXS7424 | 0.12-0.5 |
| | GATA172D05 | 0.4-0.72 |
| | HPRTB | 0.12-0.5 |
| | DXS981 | 0.12-0.5 |
| | DXS6810 | 0.12-0.5 |
| | DXS6807 | 0.4-0.72 |

Primer sequences were used with slight modifications to control amplicon overlap or preclude primer-dimer formation. The sequences of the primers were from previously reported primer pairs for each X-STR marker as follows:

### DXS7423, DXS7424, GATA165B12, DXS6789, DXS7133:

H. Asamura, H. Sakai, K. Kobayashi, M. Ota, H. Fukushima. 2006. MiniX-STR multiplex system population study in Japan and application to degraded DNA analysis. Int J Legal Med 120: 174-181.

### DXS9902:

http://www.ncbi.nlm.nih.gov/genome/sts/sts.cgi?uid=73076

### DXS6797:

http://www.ncbi.nlm.nih.gov/genome/sts/sts.cgi?uid=78431

### DXS981:

http://www.ncbi.nlm.nih.gov/genome/sts/sts.cgi?uid=99675

### DXS8377, DXS7132, DXS8378, GATA172D05, DXS6800, DXS9895:

Edelmann J, Deichsel D, Hering S, Plate I, Szibor R. 2002. Sequence variation and allele nomenclature for the X-linked STRs DXS9895, DXS8378, DXS7132, DXS6800, DXS7133, GATA172D05, DXS7423 and DXS8377. Forensic Sci Int 129:99-103.

### DXS9898:

S. Hering, R. Szibor. 2000. Development of the X-linked tetrameric microsatellite marker DXS9898 for forensic purposes, J. Forensic Sci. 45: 929-931.

### DXS101:

J. Edelmann • R. Szibor. 2001. DXS101: a highly polymorphic X-linked STR. Int J Legal Med 114:301-304.

### GATA31E08:

http://www.ncbi.nlm.nih.gov/genome/sts/sts.cgi?uid=15349

### HPRTB:

Kyoung-Jin Shin • Byung-Ki Kwon • Sang-Seob Lee • Ji-Eun Yoo • Myung Jin Park • Ukhee Chung • Hwan Young Lee • Gil-Ro Han • Jong-Hoon Choi • Chong-Youl Kim. 2004. Five highly informative X-chromosomal STRs in Koreans. Int J Legal Med 118: 37-40.

### DXS6807, DXS6810:

Sang Hee Shin, Jin Seok Yu, Sun Wha Park, Gi Sik Min, Ki Wha Chung. 2005. Genetic analysis of 18 X-linked short tandem repeat markers in Korean population. Forensic Science International 147 (2005) 35-41.

### II. PCR Sample Amplification Conditions

DNA samples were amplified in a 20-plex PCR reagent mixture as provided in Example I. Thermal cycle conditions were a heat activation step of 95° C. for 11 minutes followed by 28 cycles of 94° C., 20 seconds; 59° C., 2 minutes; 72° C., 1 minute. Then an elongation step at 60° C. for 30 minutes followed by a 4° C. hold.

All of the compositions and methods disclosed and claimed herein can be made and executed without undue experimentation in light of the present disclosure. While the compositions and methods of the present teachings may have been described in terms of specific examples or preferred embodiments, these examples and embodiments are in no way intended to limit the scope of the claims, and it will be apparent to those of skill in the art that variations may be applied to the compositions and/or methods and in the steps or in the sequence of steps of the methods described herein without departing from the concept, spirit and scope of the present teachings. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the present teachings as defined by the appended claims.

1-7. (canceled)

8. A method of determining the alleles present in at least four short tandem repeat loci from one or more DNA samples, comprising:
(a) selecting a set of at least four short tandem repeat loci of a DNA sample to be analyzed, wherein the at least four loci in the set are selected from the group of loci consisting of:
DXS101, DXS6789, DXS6797, DXS6800, DXS6807, DXS8378, DXS6810, DXS7132, DXS7133, DXS7423, DXS7424, DXS8377, DXS981, DXS9895, DXS9898, DXS9902, GATA165B12, GATA172D05, GATA31E08, HPRTB;
(b) co-amplifying the set of loci in a multiplex amplification reaction, wherein the product of the reaction is a mixture of amplified alleles from each of the co-amplified loci in the set; and
(c) evaluating the amplified alleles in the mixture to determine the alleles present at each of the loci analyzed in the set within the DNA sample.

9. The method of claim 8, wherein the set of at least four loci co-amplified therein is a set of four loci, wherein the set of four loci is selected from the group of sets of loci consisting of:
DXS6807 DXS7132 GATA172D05 GATA31E08;
DXS6807 DXS981 GATA172D05 GATA31E08;
DXS6807 DXS6800 GATA172D05 GATA31E08;
DXS6807 DXS9898 GATA172D05 GATA31E08;
DXS6807 DXS6789 GATA172D05 GATA31E08;
DXS6807 DXS7424 GATA172D05 GATA31E08;
DXS6807 DXS101 GATA172D05 GATA31E08;
DXS6807 DXS6797 GATA172D05 GATA31E08;
DXS6807 DXS7133 GATA172D05 GATA31E08;
DXS6807 DXS7132 GATA172D05 DXS7423;
DXS6807 DXS981 GATA172D05 DXS7423;
DXS6807 DXS6800 GATA172D05 DXS7423;
DXS6807 DXS9898 GATA172D05 DXS7423;
DXS6807 DXS6789 GATA172D05 DXS7423;
DXS6807 DXS7424 GATA172D05 DXS7423;
DXS6807 DXS101 GATA172D05 DXS7423;
DXS6807 DXS6797 GATA172D05 DXS7423;
DXS6807 DXS7133 GATA172D05 DXS7423;
DXS6807 DXS7132 GATA172D05 DXS8377;
DXS6807 DXS981 GATA172D05 DXS8377;
DXS6807 DXS6800 GATA172D05 DXS8377;
DXS6807 DXS9898 GATA172D05 DXS8377;
DXS6807 DXS6789 GATA172D05 DXS8377;
DXS6807 DXS7424 GATA172D05 DXS8377;
DXS6807 DXS101 GATA172D05 DXS8377;
DXS6807 DXS6797 GATA172D05 DXS8377;
DXS6807 DXS7133 GATA172D05 DXS8377;
DXS6807 DXS7132 GATA165B12, GATA31E08;
DXS6807 DXS981 GATA165B12 GATA31E08;
DXS6807 DXS6800 GATA165B12 GATA31E08;
DXS6807 DXS9898 GATA165B12 GATA31E08;
DXS6807 DXS6789 GATA165B12 GATA31E08;
DXS6807 DXS7424 GATA165B12 GATA31E08;
DXS6807 DXS101 GATA165B12 GATA31E08;
DXS6807 DXS6797 GATA165B12 GATA31E08;
DXS6807 DXS7133 GATA165B12 GATA31E08;
DXS6807 DXS7132 GATA165B12 DXS7423;
DXS6807 DXS981 GATA165B12, DXS7423;
DXS6807 DXS6800 GATA165B12, DXS7423;
DXS6807 DXS9898 GATA165B12, DXS7423;
DXS6807 DXS6789 GATA165B12, DXS7423;
DXS6807 DXS7424 GATA165B12, DXS7423;
DXS6807 DXS101 GATA165B12, DXS7423;
DXS6807 DXS6797 GATA165B12, DXS7423;
DXS6807 DXS7133 GATA165B12, DXS7423;
DXS6807 DXS7132 GATA165B12, DXS8377;
DXS6807 DXS981 GATA165B12, DXS8377;
DXS6807 DXS6800 GATA165B12, DXS8377;
DXS6807 DXS9898 GATA165B12, DXS8377;
DXS6807 DXS6789 GATA165B12, DXS8377;
DXS6807 DXS7424 GATA165B12, DXS8377;
DXS6807 DXS101 GATA165B12, DXS8377;
DXS6807 DXS6797 GATA165B12, DXS8377;
DXS6807 DXS7133 GATA165B12, DXS8377;
DXS6807 DXS7132 HPRTB, GATA31E08;
DXS6807 DXS981 HPRTB, GATA31E08;
DXS6807 DXS6800 HPRTB, GATA31E08;
DXS6807 DXS9898 HPRTB, GATA31E08;
DXS6807 DXS6789 HPRTB, GATA31E08;
DXS6807 DXS7424 HPRTB, GATA31E08;
DXS6807 DXS101 HPRTB, GATA31E08;
DXS6807 DXS6797 HPRTB, GATA31E08;
DXS6807 DXS7133 HPRTB, GATA31E08;
DXS6807 DXS7132 HPRTB, DXS7423;
DXS6807 DXS981 HPRTB, DXS7423;
DXS6807 DXS6800 HPRTB, DXS7423;
DXS6807 DXS9898 HPRTB, DXS7423;
DXS6807 DXS6789 HPRTB, DXS7423;
DXS6807 DXS7424 HPRTB, DXS7423;
DXS6807 DXS101 HPRTB, DXS7423;
DXS6807 DXS6797 HPRTB, DXS7423;
DXS6807 DXS7133 HPRTB, DXS7423;
DXS6807 DXS7132 HPRTB, DXS8377;
DXS6807 DXS981 HPRTB, DXS8377;
DXS6807 DXS6800 HPRTB, DXS8377;
DXS6807 DXS9898 HPRTB, DXS8377;
DXS6807 DXS6789 HPRTB, DXS8377;
DXS6807 DXS7424 HPRTB, DXS8377;
DXS6807 DXS101 HPRTB, DXS8377;
DXS6807 DXS6797 HPRTB, DXS8377;
DXS6807 DXS7133 HPRTB, DXS8377;
DXS8378, DXS981 and one locus selected from the group consisting of GATA 172D05, GATA165B12 and HPRTB and one locus selected from the group consisting of GATA31E08, DXS7423 and DSX8377;
DXS8378, DXS6800 and one locus selected from the group consisting of GATA 172D05, GATA165B12 and HPRTB and one locus selected from the group consisting of GATA31E08, DXS7423 and DSX8377;
DXS8378, DXS9898 and one locus selected from the group consisting of GATA 172D05, GATA165B12 and HPRTB and one locus selected from the group consisting of GATA31E08, DXS7423 and DSX8377;
DXS8378, DXS6789 and one locus selected from the group consisting of GATA 172D05, GATA165B12 and HPRTB and one locus selected from the group consisting of GATA31E08, DXS7423 and DSX8377;
DXS8378, DXS7424 and one locus selected from the group consisting of GATA 172D05, GATA165B12 and HPRTB and one locus selected from the group consisting of GATA31E08, DXS7423 and DSX8377;
DXS8378, DXS101 and one locus selected from the group consisting of GATA 172D05, GATA165B12 and HPRTB and one locus selected from the group consisting of GATA31E08, DXS7423 and DSX8377;
DXS8378, DXS6797 and one locus selected from the group consisting of GATA 172D05, GATA165B12 and HPRTB and one locus selected from the group consisting of GATA31E08, DXS7423 and DSX8377;
DXS8378, DXS7133 and one locus selected from the group consisting of GATA 172D05, GATA165B12 and HPRTB and one locus selected from the group consisting of GATA31E08, DXS7423 and DSX8377;
DXS8378, DXS981 and one locus selected from the group consisting of GATA 172D05, GATA165B12 and HPRTB and one locus selected from the group consisting of GATA31E08, DXS7423 and DSX8377;
DXS8378, DXS981 and one locus selected from the group consisting of GATA 172D05, GATA165B12 and HPRTB and one locus selected from the group consisting of GATA31E08, DXS7423 and DSX8377;
DXS9895, DXS7132 and one locus selected from the group consisting of GATA 172D05, GATA165B12 and HPRTB and one locus selected from the group consisting of GATA31E08, DXS7423 and DSX8377;
DXS9895, DXS981 and one locus selected from the group consisting of GATA 172D05, GATA165B12 and HPRTB and one locus selected from the group consisting of GATA31E08, DXS7423 and DSX8377;
DXS9895, DXS6800 and one locus selected from the group consisting of GATA 172D05, GATA165B12 and HPRTB and one locus selected from the group consisting of GATA31E08, DXS7423 and DSX8377;
DXS9895, DXS9898 and one locus selected from the group consisting of GATA 172D05, GATA165B12 and HPRTB and one locus selected from the group consisting of GATA31E08, DXS7423 and DSX8377;
DXS9895, DXS6789 and one locus selected from the group consisting of GATA 172D05, GATA165B12 and HPRTB and one locus selected from the group consisting of GATA31E08, DXS7423 and DSX8377;
DXS9895, DXS7424 and one locus selected from the group consisting of GATA 172D05, GATA165B12 and HPRTB and one locus selected from the group consisting of GATA31E08, DXS7423 and DSX8377;
DXS9895, DXS101 and one locus selected from the group consisting of GATA 172D05, GATA165B12 and HPRTB and one locus selected from the group consisting of GATA31E08, DXS7423 and DSX8377;
DXS9895, DXS6797 and one locus selected from the group consisting of GATA 172D05, GATA165B12 and HPRTB and one locus selected from the group consisting of GATA31E08, DXS7423 and DSX8377;
DXS9895, DXS7133 and one locus selected from the group consisting of GATA 172D05, GATA165B12 and HPRTB and one locus selected from the group consisting of GATA31E08, DXS7423 and DSX8377;
DXS9902, DXS7132 and one locus selected from the group consisting of GATA 172D05, GATA165B12 and HPRTB and one locus selected from the group consisting of GATA31E08, DXS7423 and DSX8377;
DXS9902, DXS981 and one locus selected from the group consisting of GATA 172D05, GATA165B12 and HPRTB and one locus selected from the group consisting of GATA31E08, DXS7423 and DSX8377;
DXS9902, DXS6800 and one locus selected from the group consisting of GATA 172D05, GATA165B12 and HPRTB and one locus selected from the group consisting of GATA31E08, DXS7423 and DSX8377;
DXS9902, DXS9898 and one locus selected from the group consisting of GATA 172D05, GATA165B12 and HPRTB and one locus selected from the group consisting of GATA31E08, DXS7423 and DSX8377;
DXS9902, DXS6789 and one locus selected from the group consisting of GATA 172D05, GATA165B12 and HPRTB and one locus selected from the group consisting of GATA31E08, DXS7423 and DSX8377;
DXS9902, DXS7424 and one locus selected from the group consisting of GATA 172D05, GATA165B12 and HPRTB and one locus selected from the group consisting of GATA31E08, DXS7423 and DSX8377;
DXS9902, DXS101 and one locus selected from the group consisting of GATA 172D05, GATA165B12 and HPRTB and one locus selected from the group consisting of GATA31E08, DXS7423 and DSX8377;
DXS9902, DXS6797 and one locus selected from the group consisting of GATA 172D05, GATA165B12 and HPRTB and one locus selected from the group consisting of GATA31E08, DXS7423 and DSX8377;
DXS9902, DXS7133 and one locus selected from the group consisting of GATA 172D05, GATA165B12 and HPRTB and one locus selected from the group consisting of GATA31E08, DXS7423 and DSX8377;
DXS6810, DXS7132 and one locus selected from the group consisting of GATA 172D05, GATA165B12 and HPRTB and one locus selected from the group consisting of GATA31E08, DXS7423 and DSX8377;
DXS6810, DXS981 and one locus selected from the group consisting of GATA 172D05, GATA165B12 and HPRTB and one locus selected from the group consisting of GATA31E08, DXS7423 and DSX8377;
DXS6810, DXS6800 and one locus selected from the group consisting of GATA 172D05, GATA165B12 and HPRTB and one locus selected from the group consisting of GATA31E08, DXS7423 and DSX8377;
DXS6810, DXS9898 and one locus selected from the group consisting of GATA 172D05, GATA165B12 and HPRTB and one locus selected from the group consisting of GATA31E08, DXS7423 and DSX8377;
DXS6810, DXS6789 and one locus selected from the group consisting of GATA 172D05, GATA165B12 and HPRTB and one locus selected from the group consisting of GATA31E08, DXS7423 and DSX8377;
DXS6810, DXS7424 and one locus selected from the group consisting of GATA 172D05, GATA165B12 and HPRTB and one locus selected from the group consisting of GATA31E08, DXS7423 and DSX8377;
DXS6810, DXS101 and one locus selected from the group consisting of GATA 172D05, GATA165B12 and HPRTB and one locus selected from the group consisting of GATA31E08, DXS7423 and DSX8377;
DXS6810, DXS6797 and one locus selected from the group consisting of GATA 172D05, GATA165B12 and HPRTB and one locus selected from the group consisting of GATA31E08, DXS7423 and DSX8377; and
DXS6810, DXS7133 and one locus selected from the group consisting of GATA 172D05, GATA165B12 and HPRTB and one locus selected from the group consisting of GATA31E08, DXS7423 and DSX8377.

10. The method of claim 8, wherein the at least four loci are co-amplified by multiplex polymerase chain reaction.

11. The method of claim 8, wherein the amplified alleles are evaluated by separating the alleles and comparing the separated alleles to a size standard selected from a DNA size marker or a locus-specific allelic ladder.

12. The method of claim 8, further comprising the step of separating the alleles by electrophoresis.

13. The method of claim 12 wherein the separated alleles are detected by capillary electrophoresis

14. The method of claim 12 wherein the separated alleles are detected by fluorescence detection.

15. The method of claim 8 wherein the at least one DNA sample to be analyzed is selected from the group consisting of hair, feces, blood, tissue, urine, saliva, cheek cells, vaginal cells, skin, bone, tooth, buccal sample, amniotic fluid containing placental cells, amniotic fluid containing fetal cells, semen and mixtures of body fluids.

16. A method of human identification by determining the alleles present in at least four short tandem repeat loci from one or more DNA samples, comprising:
(a) selecting a set of at least four short tandem repeat loci of a DNA sample to be analyzed, wherein the at least four loci in the set are selected from the group of loci consisting of:
a. DXS101, DXS6789, DXS6797, DXS6800, DXS6807, DXS8378, DXS6810, DXS7132, DXS7133, DXS7423, DXS7424, DXS8377, DXS981, DXS9895, DXS9898, DXS9902, GATA165B12, GATA172D05, GATA31E08, HPRTB;
(b) co-amplifying the set of loci in a multiplex amplification reaction, wherein the product of the reaction is a mixture of amplified alleles from each of the co-amplified loci in the set; and
(c) evaluating the amplified alleles in the mixture to determine the alleles present at each of the loci analyzed in the set within the DNA sample.

17. (canceled)

18. A method of paternity testing by determining the alleles present in at least four short tandem repeat loci from one or more DNA samples, comprising:
(a) selecting a set of at least four short tandem repeat loci of a DNA sample to be analyzed, wherein the at least four loci in the set are selected from the group of loci consisting of:
a. DXS101, DXS6789, DXS6797, DXS6800, DXS6807, DXS8378, DXS6810, DXS7132, DXS7133, DXS7423, DXS7424, DXS8377, DXS981, DXS9895, DXS9898, DXS9902, GATA165B12, GATA172D05, GATA31E08, HPRTB;
(b) co-amplifying the set of loci in a multiplex amplification reaction, wherein the product of the reaction is a mixture of amplified alleles from each of the co-amplified loci in the set; and
(c) evaluating the amplified alleles in the mixture to determine the alleles present at each of the loci analyzed in the set within the DNA sample.

19-42. (canceled)

43. A method of identifying an individual, the method comprising determining an allele of at least 4 X-STR markers selected from the group consisting of DXS101, DXS6789, DXS6797, DXS6800, DXS6807, DXS8378, DXS6810, DXS7132, DXS7133, DXS7423, DXS7424, DXS8377, DXS981, DXS9895, DXS9898, DXS9902, GATA165B12, GATA172D05, GATA31E08, and HPRTB.

44. The method of claim 43, wherein the allele is identified by PCR.

45. The method of claim 44, wherein the PCR is a multiplex PCR that co-amplifies the at least 4 X-STR markers.

46. The method of claim 44, wherein the PCR uses primers that are labeled with a fluorescent dye.

47. The method of claim 43, wherein the allele is identified by mass spectroscopy.

48. The method of claim 43, wherein the PCR co-amplifies at least one the loci and an autosomal STR

49. The method of claim 48, wherein the autosomal STR is selected from the group consisting of D3S1358, vWA, FGA, D8S1179, D21S11, D18S51, D5S818, D13S317, D7S820, D16S539, THOI, TPDX, and CSFIPO.

50. A kit for identifying the allele of at least 4 X chromosome STRS markers, wherein the markers are selected from the group consisting of DXS101, DXS6789, DXS6797, DXS6800, DXS6807, DXS8378, DXS6810, DXS7132, DXS7133, DXS7423, DXS7424, DXS8377, DXS981, DXS9895, DXS9898, DXS9902, GATA165B12, GATA172D05, GATA31E08, and HPRTB, the kit comprising primers for the amplification of at least 4 loci, and an allelic ladder representative of the selected markers.

51. An allelic ladder size standard for calling one or more alleles of an STR from at least 4 of the X-STR markers selected from the group consisting of DXS101, DXS6789, DXS6797, DXS6800, DXS6807, DXS8378, DXS6810, DXS7132, DXS7133, DXS7423, DXS7424, DXS8377, DXS981, DXS9895, DXS9898, DXS9902, GATA165B12, GATA172D05, GATA31E08, and HPRTB.


SEQUENCE LISTING (8 sequences)

SEQ ID NO: 1 - DNA, 83 bp, Artificial Sequence
  Description of Artificial Sequence Synthetic oligonucleotide
ctgtctatctatctgtctgtctatctatctatctatctatctatctatctatctatctatctatctatctatctatcatctat

SEQ ID NO: 2 - DNA, 60 bp, Artificial Sequence
  Description of Artificial Sequence Synthetic oligonucleotide
ctatctatctatctatctatctatctatctatctatctatctatctatctatctatctat

SEQ ID NO: 3 - DNA, 20 bp, Artificial Sequence
  Description of Artificial Sequence Synthetic oligonucleotide
atcgatcgaacgatcgatcg

SEQ ID NO: 4 - DNA, 39 bp, Artificial Sequence
  Description of Artificial Sequence Synthetic oligonucleotide
aatgaatgaatgaatgaatgaatgatgaatgaatgaatg

SEQ ID NO: 5 - DNA, 28 bp, Artificial Sequence
  Description of Artificial Sequence Synthetic oligonucleotide
atccatcgatccatcgatcgatccatcc

SEQ ID NO: 6 - DNA, 68 bp, Artificial Sequence
  Description of Artificial Sequence Synthetic oligonucleotide
tctatctatctatctatctatctatctatctatctatctatctatctatctatctatctatctatcta

SEQ ID NO: 7 - DNA, 28 bp, Artificial Sequence
  Description of Artificial Sequence Synthetic oligonucleotide
agatagatagatagatagatagatagat

SEQ ID NO: 8 - DNA, 36 bp, Artificial Sequence
  Description of Artificial Sequence Synthetic oligonucleotide
aatgaatgaatgaatgaatgaatgaatgaatgaatg